(19) United States
(12) Patent Application Publication
(10) Pub. No.: US 2026/0189631 A1
(43) Pub. Date: Jul. 2, 2026

(54) METHOD FOR MANAGING SERVICE PROFILES OF A SECURE ELEMENT

(71) Applicant: IDEMIA FRANCE, Courbevoie (FR)

(72) Inventors: Katarzyna WISNIEWSKA, Courbevoie (FR); Tomasz WOZNIAK, Courbevoie (FR); Pawel KARPINSKI, Courbevoie (FR); Jacek MACUDA, Courbevoie (FR); Marek KOCIECKI, Courbevoie (FR)

(73) Assignee: IDEMIA FRANCE, Courbevoie (FR)

(21) Appl. No.: 18/867,922

(22) PCT Filed: May 11, 2023
(86) PCT No.: PCT/EP2023/062659

§ 371 Date: Nov. 21, 2024

(30) Foreign Application Priority Data
May 23, 2022 (FR) FR2204935

(51) Int. Cl. H04L 67/303; H04L 9/08; H04L 9/14; H04L 67/51

(52) U.S. Cl. CPC H04L 67/303; H04L 9/0825; H04L 9/14; H04L 67/51

(57) ABSTRACT

The invention proposes a novel method for managing service profiles of a secure element, the managing method being implemented by a centralized profile management device and comprising: receiving profile data corresponding to one and the same service from a plurality of processing devices; storing in memory profile data from among the received profile data, associated with said service; detecting an event triggering an update of a service profile of the secure element for said service; and, upon detection of said event, sending the most recent profile datum from among the stored profile data associated with said service to the host terminal.

### TECHNICAL FIELD

The present invention relates to the management of service profiles in a secure element of a host terminal.

### PRIOR ART

A secure element, SE, is a tamper-proof hardware component or platform (typically a chip or a chip card) used in a host terminal (typically a mobile terminal) and capable of securely hosting applications and data in compliance with security rules and requirements set by trusted authorities.

One form factor of the SE that is increasingly being used is the embedded secure element, eSE. This embedded secure element is generally soldered to the host terminal. One more recent form factor is the integrated secure element, iSE. The secure element then forms an integral part of the main processor (for example as a secure core, in addition to other cores of the processor).

Secure elements are programmed according to the desired applications.

By way of example, an eSE or ISE may form the secure element necessary for numerous uses or services based on NFC (near-field communication) communication implemented by a host mobile terminal. For example, an NFC payment service requires secret banking information from the user, which is advantageously stored in the eSE, protected from any unwanted access. This is also the case for a public transport service, where the eSE makes it possible to identify the user at access gates.

Another example of a secure element is the embedded UICC (universal integrated circuit card), which provides the credentials of a subscriber to authenticate themselves on one or more mobile telephony networks, in particular via various operators. For example, this is an eSE or iSE configured as a SIM (subscriber identity module) card. Reference is then made to an eUICC (for embedded UICC) or iUICC (for integrated UICC). The main specifications of an eUICC card are defined by the GSMA (Global System for Mobile Communications Association) group in the GSMA standard SGP.02 v3.2 entitled “Remote Provisioning Architecture for Embedded UICC—Technical Specification—Version 3.2” dated Jun. 27, 2017.

The main benefit of these secure elements is that of offering multiple services using one and the same secure element. Multiple service providers therefore have to load data and/or applications into the same secure element allowing a user to access their services. These data and/or applications specific to a service provider for a user form a service profile (or simply a “profile” hereinafter) that is stored in the secure element. In particular, profiles within the meaning of the GSMA RSP Technical Specification, version 2.2 of Sep. 1, 2017 (GSMA SGP.22 below) that are associated with mobile operators (service providers) and contain information in relation to the user, allowing them to access the mobile telephony services of said mobile operators, are known. Configurations within the meaning of the GlobalPlatform Card Specification standard (version 2.3 of October 2015) that are associated with authorities (service providers) and contain information in relation to the user, allowing them to access the respective services of said authorities, are also known.

According to the GSMA standard, these profiles are managed by an entity called LPA (local profile administration). The LPA is located in the operating system of the host terminal or in the secure element of the host terminal and forms the interface between the secure element and the entity, on the communication network, of the profile management operator (for example the SM-DP+, subscription manager data preparation+, subscription management server). This allows the user of the host terminal, for example, to install a new profile in the secure element, or else to enable, disable or delete a profile that is already installed in the secure element.

Nowadays, with the development of the Internet of Things (IoT), which represents tens or even hundreds of thousands of connected apparatuses comprising secure elements storing profiles associated with new services, it is necessary to think about solutions for the effective remote management of such profiles.

A system in accordance with FIG. 1 has in particular been proposed, in which the functions for the remote management of service profiles are implemented by devices CLPAᵢ external to the host terminal, located in the communication network.

More precisely, FIG. 1 shows a host terminal 101 comprising a secure element 102, for example an eUICC, and a communication agent 103. The host terminal 101 may be for example a mobile telephone, a device embedded in a car and managed remotely by the information system of the car manufacturer, or any other type of connected object. The secure element 102 typically stores one or more profiles. The communication agent 103 is located in the operating system of the host terminal 101 or in the secure element 102 of the host terminal 101 and forms the interface between the secure element 102 and the various external profile management devices CLPAᵢ 105a, 105b, 105c, as detailed below.

The system of FIG. 1 also comprises an SM-DP+ (subscription manager data preparation) server 104 of a mobile network, which server stores or receives multiple profiles to be transmitted to the secure element 102. Various types of remote server may be used, for example the SM-DP+ server 104 may be replaced by two SM-DP and SM-SR servers.

The profiles stored on the secure element 102 are managed by a plurality of external profile management devices CLPAᵢ 105a, 105b, 105c that are not in the host terminal 101, but are devices (or servers) that are remote in the network. In this respect, the external profile management devices CLPAᵢ 105a, 105b, 105c, for the services respectively associated therewith, carry out the profile management functions instead of the LPA entity defined for example in the GSMA standard SGP.22 v2.0 entitled “RSP Technical Specification—Version 2.0” dated Oct. 14, 2016.

Each external profile management device CLPAᵢ 105a, 105b, 105c is thus configured to communicate, on the one hand, with the SM-DP+ server 104 and to obtain one (or more) command(s) relating to the management of a profile of the secure element 102 (for example a command to install or delete a profile) and, on the other hand, with the communication agent 103 of the host terminal 101 in order to send said profile management command thereto. The communication agent 103 is furthermore configured to send the profile management command to the secure element 102.

Such a system is described in detail in application FR 3 111 042.

However, in view of the ever-increasing number of services associated with one and the same secure element, and therefore the increasingly large number of external profile management devices, such a system is not entirely satisfactory.

Indeed, since external profile management devices communicate (directly or via the management platform for managing the terminal) with the host terminal, it is necessary, in order to secure access to the secure element, for the premises hosting the external profile management devices to be certified by a certification authority. However, such certifications represent a non-negligible cost, in which not all service providers necessarily want to invest.

Furthermore, this system does not make it possible to effectively manage the evolution of external profile management devices for a given service (for example, an external profile management device that is out of service, or that is not capable of updating the profile, replacing one external profile management device with another, etc.). For example, for a given service, migration to a new service provider involves changing the profile management device associated with this service. The secure element is not informed of this evolution, and does not know the address of the new profile management device. There is at present no mechanism provided for switching to a new external profile management device for a pre-existing service.

There is therefore a need to improve the management of service profiles stored in a secure element.

### SUMMARY OF THE INVENTION

A first aspect of the invention relates to a method for managing service profiles of a secure element of a host terminal, the management method being implemented by a centralized profile management device external to the host terminal. The method may comprise:
receiving, from a plurality of processing devices, profile data corresponding to one and the same service and intended for the secure element;
storing in memory profile data from among the received profile data, each stored profile datum being stored in association with said service;
detecting an event that triggers updating of a service profile of the secure element for said service; and
upon detection of said event, sending, to the host terminal, the most recent profile datum from among the stored profile data associated with said service.

A “profile datum” is understood to mean one or more data associated with a service profile for installing or updating a profile on the secure element. A “processing device” may be an external device or server managed by a service provider and on which profile data associated with one or more services managed by the service provider are stored. Hereinafter, a processing device is also called a “profile management device”. An “event that triggers updating of a service profile” is understood to mean any event that leads to the search for and the sending of a profile datum from among the profile data stored in the centralized profile management device 206. For example, the centralized profile management device may receive an interrogation request from the secure element (“pull mode”), or may be configured to check, at predetermined times, whether a profile datum is available, and send it, where applicable, to the secure element.

The above method advantageously makes it possible to manage the case where multiple profile data corresponding to one and the same service are received from at least two different processing devices, which was not possible with the architecture of FIG. 1. Furthermore, the presence of a centralized management device as the only entity with which the host terminal communicates makes it possible to eliminate certification problems.

In one or more embodiments, the sent profile datum may be sent by the centralized profile management device to a communication agent of the host terminal, the communication agent being configured to transmit said profile datum to the secure element.

In one or more embodiments, the centralized profile management device May furthermore receive other profile data that are intended for at least one other secure element, wherein each profile datum is received with an identifier of a secure element for which it is intended, wherein each stored profile datum is furthermore stored in association with the identifier of the secure element for which it is intended, and wherein the most recent profile datum from among the stored profile data associated with said service is sent with the identifier of the secure element for which it is intended.

In other words, the centralized profile management device may be configured to manage the profiles of a plurality of secure elements that do or do not belong to the same host terminal. In this case, each profile datum received from a processing device may comprise an identifier of the secure element for which it is intended.

Furthermore, each stored profile datum may be associated, respectively, with a version datum, wherein the version datum is representative of a time of receipt by the centralized profile management device or is a version number of a profile associated with the profile datum, wherein the sent profile datum corresponds to the profile datum having the most recent version datum from among the stored profile data associated with said service.

In one or more embodiments, each profile datum may be received with a respective service identification datum, and the method may furthermore comprise:
for each profile datum received and stored in memory, determining a corresponding service based on the respective service identification datum received with said profile datum and storing the profile datum in association with the determined corresponding service.

For example, a service identification datum from among the received service identification data may be:
an identifier of the processing device from which the profile datum was received;
a network address of the processing device from which the profile datum was received;
an identifier of a service provider managing a service associated with the received profile datum; or
an identifier of a service associated with the received profile datum.

Each profile datum is thus received with information that makes it possible to determine the service to which it corresponds. It is thus possible, when storing the profile datum, to associate said datum and the corresponding service.

In one or more embodiments, the method may furthermore comprise, for each received profile datum associated with the service:
determining a service provider associated with the profile datum and storing the profile datum in association with the determined service provider;
upon detection of said event, determining, based on a database, a current service provider associated with the secure element for said service;
wherein the sent profile datum is the most recent profile datum from among the stored profile data associated with said service and the current service provider associated with the secure element for said service.

A “current service provider” is understood to mean the provider of the service at the time when the trigger event is detected. Indeed, between the receipt of at least some of the profile data and the detection of the trigger event, the provider of the service in question may have changed. In this case, the profile datum sent to the terminal is chosen from among the profile data stored in the centralized profile management device and associated with the current provider of the service.

In one or more embodiments, the detection of the event that triggers updating of the service profile of the secure element may comprise:
receiving, from the host terminal or from a management platform for managing the host terminal, an interrogation request comprising identification information in relation to said given service.

Such embodiments correspond to a “pull” mode. The host terminal sends a request corresponding to a given service to ask whether a new version of the profile associated with the service is available, and retrieve it if so. In the system of FIG. 1, in the event of a change of network address of the processing device to which the interrogation request is sent, this request is lost or sent to the wrong entity. Indeed, nothing is provided to dynamically manage changes of network address or provider. In the present invention, this problem no longer arises because all interrogation requests are sent to one and the same entity the network address of which is fixed.

The interrogation request may furthermore comprise an identifier of the secure element.

In one or more embodiments, each processing device from among the plurality of processing devices may have a respective first asymmetric key pair, each first asymmetric key pair comprising a private key and a public key, the public key being shared between the processing device and the centralized profile management device. Each received profile datum may be signed with the private key of the issuing processing device. The method may furthermore comprise, for each received profile datum:
the centralized profile management device checking the signature of the profile datum based on the public key of the issuing processing device; and
storing the received profile datum in the memory of the centralized profile management device only if the check is successful.

An issuing processing device is understood to mean the processing device from which the profile datum was received. Such checking of the signature of the processing device makes it possible to check that the profile datum was indeed issued by an authorized and trusted entity, and that it has not been corrupted between sending and receipt thereof. In some embodiments, the public key of the processing device may be broadcast to the centralized profile management device in a digital certificate.

Furthermore, the centralized profile management device may have a second asymmetric key pair, the second asymmetric key pair comprising a private key of the centralized profile management device and a public key of the centralized profile management device, the public key of the second asymmetric key pair being shared between the centralized profile management device and the secure element. For each stored profile datum, said profile datum may be signed using the private key of the centralized profile management device.

This signature may be additional to the first signature above. According to this embodiment, the profile datum is therefore doubly signed, firstly with the private key of the issuing processing device, and secondly with the private key of the centralized profile management device. The public key of the second asymmetric key pair (therefore the public key of the centralized profile management device) may be sent to the secure element in a second digital certificate. In this embodiment, the public keys of the processing devices also have to be communicated to the secure element (for example, the certificate of each processing device may be sent from the centralized profile management device to the secure element, and this certificate may possibly be signed using the private key of the centralized profile management device). This allows the secure element, when it receives the profile datum, to check that it has not been modified since it was sent by the processing device, and to “trace” its path (issuing processing device-centralized profile management device-secure element).

Another aspect of the invention relates to a centralized profile management device for managing communication profiles of a secure element of a host terminal, the centralized profile management device being external to the host terminal. The centralized profile management device may be configured to:
receive, from a plurality of processing devices, profile data corresponding to one and the same service and intended for the secure element;
store in memory profile data from among the received profile data, each stored profile datum being stored in association with said service;
detect an event that triggers updating of a service profile of the secure element for said service; and
upon detection of said event, send, to the host terminal, the most recent profile datum from among the stored profile data associated with said service.

Another aspect of the invention relates to a system comprising a host terminal having a secure element, a centralized profile management device external to the host terminal and a plurality of processing devices, wherein the centralized profile management device may be configured to:
receive, from a plurality of processing devices, profile data corresponding to one and the same service and intended for the secure element;
store in memory profile data from among the received profile data, each stored profile datum being stored in association with said service;
detect an event that triggers updating of a service profile of the secure element for said service; and
upon detection of said event, send, to the host terminal, the most recent profile datum from among the stored profile data associated with said service.

The secure element may be configured to:
receive the profile datum sent by the centralized profile management device; and
update the service profile based on the received profile datum.

Furthermore, each processing device from among the plurality of processing devices may have a respective first asymmetric key pair, each first asymmetric key pair comprising a private key and a public key, the public key being shared between the processing device and the centralized profile management device. Each received profile datum may be signed with the private key of the issuing processing device, and the centralized profile management device may furthermore be configured, for each received profile datum, to:
check the signature of the profile datum based on the public key of the issuing processing device; and
store the received profile datum in memory only if the check is successful.

In one or more embodiments, the centralized profile management device may have a second asymmetric key pair, the second asymmetric key pair comprising a private key of the centralized profile management device and a public key of the centralized profile management device, the public key of the second asymmetric key pair being shared between the centralized profile management device and the secure element. For each stored profile datum, said profile datum may be signed (possibly in addition to the first signature above) using the private key of the centralized profile management device before being sent to the host terminal.

The public key of each processing device from among the plurality of processing devices may be shared with the secure element, and the secure element may be configured to:
upon receipt of the signed profile datum, check the associated signatures using the public key of the processing device that issued the profile datum and the public key of the centralized profile management device; and
update the service profile based on the received profile datum only if the check is successful.

Another aspect of the invention relates to a computer program product comprising instructions for implementing the above method when this program is executed by a processor.

Another aspect of the invention relates to a non-transient computer-readable medium storing a program that, when it is executed by a processor of a centralized profile management device, causes the centralized profile management device to carry out the method as defined above.

At least some of the methods according to the invention may be computer-implemented. As a result, the present invention may take the form of an embodiment completely in the form of hardware, of an embodiment completely in the form of software (comprising firmware, resident software, microcode, etc.) or of an embodiment combining software and hardware aspects, which may then all together be called a “circuit”, “module” or “system” here. The present invention may additionally take the form of a computer program product incorporated into any tangible expression medium having a program code able to be used by a computer incorporated into the medium.

Given that the present invention may be implemented in software, the present invention may be incorporated in the form of computer-readable code to be supplied to a programmable apparatus on any appropriate medium. A tangible or non-transient medium may comprise a storage medium such as a hard drive reader, a magnetic tape device or a semiconductor memory device and the like. A transient medium may comprise a signal such as an electrical signal, an electronic signal, an optical signal, an acoustic signal, a magnetic signal or an electromagnetic signal, for example a microwave or RF (radiofrequency) signal.

### BRIEF DESCRIPTION OF THE DRAWINGS

Other particular features and advantages of the invention will become more clearly apparent from the following description, which is illustrated by the appended figures, which illustrate some non-limiting exemplary embodiments thereof.

FIG. 1 shows one example of a communication system from the prior art comprising external profile management devices.

FIG. 2 shows one example of a communication system comprising a centralized profile management device according to one or more embodiments of the invention.

FIG. 3 shows one example of a flowchart of a method for managing a service profile according to one or more embodiments of the invention.

FIG. 4 shows steps of a method for managing a service profile according to one particular embodiment of the invention.

FIG. 5 shows one alternative embodiment to the embodiment shown in FIG. 4.

FIG. 6 shows one example of a centralized profile management device for carrying out a transaction according to one or more embodiments of the invention.

### DETAILED DESCRIPTION

The invention proposes to modify the architecture from the prior art with a view to integrating an external profile management device (or server) that is configured to receive, from the various service providers, and retransmit, to a host terminal integrating a secure element, profile data for installing or updating profiles corresponding to various services of this secure element. In other words, the profile data are no longer sent directly from the servers associated with the various providers to the host terminal, but are sent to what is referred to as a centralized profile management device, which retransmits at least some of said profile data to the host terminal. As detailed below, such an architecture makes it possible to efficiently manage situations in which data corresponding to one and the same service are sent by multiple servers (for example in the context of a change of service provider). The proposed system furthermore makes it possible to eliminate the need for each provider to have certification for each of the premises in which the servers are located. Indeed, since the data are sent from the centralized profile management device, only the premises hosting the latter require certification.

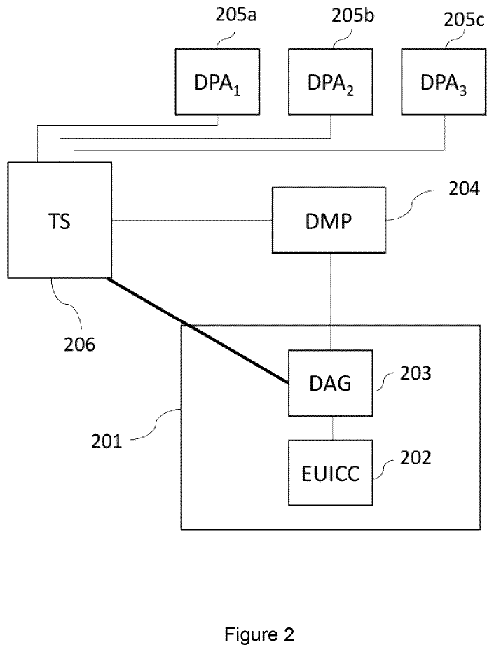

FIG. 2 shows one example of a communication system comprising a centralized profile management device according to one or more embodiments of the invention.

The system shown in FIG. 2 comprises a host terminal 201 comprising a secure element 202, for example an eUICC, and a communication agent (denoted DAG in FIG. 2) 203. The host terminal 201 may be for example a mobile telephone, a device embedded in a car and managed remotely by the information system of the car manufacturer, or any other type of connected object. The secure element 202 typically stores one or more profiles (also called “service profiles” or “subscriptions”). Each profile is associated with a service provided by an operator called a “service provider”. Each service provider may have a profile management device (or server) DPAᵢ 205a, 205b, 205c (DPA standing for distant profile administrator, although any other terminology may be used) on which profiles associated with this service are stored. For example, a profile management device DPAᵢ 205a, 205b, 205c may store the most recent version of a profile for the service in question, and possibly earlier versions of this profile (for example, each new available version of the service profile may be stored in the profile management device DPAᵢ 205a, 205b, 205c in addition to or instead of the previous version).

The communication agent 203 is located in the operating system of the host terminal 201 or in the secure element 202 of the host terminal 201 and forms the interface between the secure element 202 and the centralized profile management device (denoted TS in FIG. 2) 206, the functions of which are detailed below. As an alternative, the host terminal may be managed by a remote management platform 204 for managing the terminal (denoted DMP for device management platform). In this case, the communication agent 203 forms the interface between the secure element 202 and the remote management platform 204 for managing the terminal.

The system of FIG. 2 furthermore comprises a centralized profile management device TS 206. This centralized profile management device 206 is configured to receive, from the external profile management devices DPA 205a, 205b, 205c, data associated with service profiles (called “profile data”) prepared thereby. The profile data sent by the profile management devices DPAᵢ 205a, 205b, 205c may be complete profiles (that is to say a set of data constituting a profile), for example new profiles to be installed, or data for updating profiles that are already installed on the secure element 202. For the sake of simplification, the term “updating” of a profile is used hereinafter to designate both the installation of a new profile on the secure element 202 or the updating of a profile that is already installed on the secure element 202.

For example, each external profile management device DPAᵢ 205a, 205b, 205c may send, to the centralized profile management device 206, profile data corresponding to one or more profiles for the services that they implement.

In one or more embodiments, the profile data may be sent by the profile management devices DPAᵢ 205a, 205b, 205c to the centralized profile management device 206 in association with an identifier of the secure element 202 for which they are intended. Indeed, although FIG. 2 shows only a single secure element 202, the centralized profile management device 206 may receive profile data for the secure elements of multiple host terminals, and/or for multiple secure elements of one and the same host terminal. In this case, it is necessary for the centralized profile management device 206 to know the secure element for which a profile datum that it receives is intended.

Furthermore, in one or more embodiments, a profile datum may be sent by a profile management device DPAᵢ 205a, 205b, 205c to the centralized profile management device 206 in association with a service identification datum. This service identification datum allows the centralized profile management device 206 to determine the service to which the received profile datum corresponds. The service identification datum may be for example:
an identifier of the external profile management device DPAᵢ 205a, 205b, 205c from which the profile datum was sent;
a network address (for example an IP address) of the external profile management device DPAᵢ 205a, 205b, 205c from which the profile datum was sent;
an identifier of the service provider managing the external profile management device DPAᵢ 205a, 205b, 205c from which the profile datum was sent; or
an identifier of the service associated with the received profile datum.

In the first three examples, the centralized profile management device 206 may furthermore have access to a table (for example stored in a memory of the centralized profile management device 206 or on a remote server) or a database associating the identifier or address with an identifier of the service associated with the received profile datum. The centralized profile management device 206 is able to use this table to determine, based on the received service identification datum, the service associated with the received datum. Of course, examples other than those mentioned above are possible, provided that the service identification datum makes it possible to determine the service associated with the received profile datum.

When the centralized profile management device 206 receives a profile datum from a profile management device DPAᵢ 205a, 205b, 205c, it stores it in memory, in association with the service with which it is associated. In one or more embodiments, this association may be carried out based on the service identifier.

It should be noted that, for one and the same service, multiple profile data may be received from different profile management devices DPAᵢ 205a, 205b, 205c. Such a situation may occur for example when the user changes service provider. For example, a first profile management device (for example DPA₁ 205a) may send a first profile datum associated with a given service before the change of provider, and a second profile management device (for example DPA₂ 205b) may send a second profile datum associated with the same service after the change of provider.

In one or more embodiments, each profile management device DPAᵢ 205a, 205b, 205c has a respective asymmetric key pair, each pair being formed of a public key K_{CPA,pub,i} and a private key K_{CPA,priv,i}. The public key K_{CPA,pub,i} of each profile management device DPAᵢ 205a, 205b, 205c is shared with the centralized profile management device 206 (that is to say the centralized profile management device 206 knows the public key K_{CPA,pub,i} of each profile management device DPAᵢ 205a, 205b, 205c). In some embodiments, the public key K_{CPA,pub,i} of a profile management device DPAᵢ 205a, 205b, 205c may be sent in a digital certificate issued by a certification body to the profile management device DPAᵢ 205a, 205b, 205c. A profile management device DPAᵢ 205a, 205b, 205c may then send, to the centralized profile management device 206, a signed profile datum with a signature generated using the private key K_{CPA,priv,i} of the profile management device DPAᵢ 205a, 205b, 205c. When the centralized profile management device 206 receives the profile datum, it checks the signature: it in turn computes a signature based on this datum and on the public key K_{CPA,pub,i} of the profile management device DPAᵢ 205a, 205b, 205c from which it received the profile datum, and then compares the two signatures. If the two signatures match, this indicates that the profile datum was indeed sent by an “authorized” entity, and the datum is stored in a memory of the centralized profile management device 206. If the two signatures do not match, the profile datum is deleted and is not stored in the memory of the centralized profile management device 206. This makes it possible to check the integrity and the origin (traceability) of the received data.

Next, the centralized profile management device 206 may send one or more profile data from among the profile data that it has stored in memory directly to the communication agent 203 (for example following a direct request from the agent 203 to the centralized device 206) or, as a variant, to the remote management platform 204 for managing the terminal (which remote management platform transmits them to the communication agent 203). The communication agent 203 then transmits the one or more profile data to the secure element 202, which may install or update one or more corresponding profiles. The profile data may be sent in association with a service identification datum (detailed above), so that the secure element is able to determine the profile to be updated, and/or in association with the profile management device DPAᵢ 205a, 205b, 205c from which the profile datum was sent (this is particularly advantageous when the datum is signed using a private key K_{CPA,priv,i} of the issuing profile management device, as detailed below, so that the secure element is able to check the signature using the public key K_{CPA,pub,i} of the issuing profile management device). As an alternative or in addition, the profile data may be sent in association with an identifier of the secure element (this is particularly advantageous when the terminal comprises multiple secure elements 202, so that the communication agent 203 sends the datum to the secure element 202 comprising the profile concerned by the update).

As mentioned above, the centralized profile management device 206 may store multiple profile data associated with one and the same service and received from multiple respective profile management devices DPAᵢ 205a, 205b, 205c. It may therefore be necessary for the centralized profile management device 206 to know, for a given service, which profile datum associated with this service to send to the communication agent 203 or to the remote management platform 204 for managing the terminal. In one or more embodiments, for a given service, it is the most recent profile datum from among the stored profile data associated with this service that is sent. For example, it is possible, for each stored profile datum, to record its date of receipt, or any information representative of this date, by the centralized profile management device 206, and the sent profile datum is the one having the most recent date of receipt (that is to say the last received profile datum). As an alternative, each stored profile datum may be recorded with a version number of the corresponding profile, and the sent profile datum is the one corresponding to the most recent version.

When the centralized profile management device 206 manages profiles for a plurality of secure elements, the profile datum may furthermore be stored in association with the identifier of the secure element for which the profile datum is intended, and the sent profile datum may be the most recent profile datum from among the stored profile data associated with this service and with the identifier of the secure element 202. As an alternative, the profile datum may be sent with an identifier of the provider of the associated service, and the centralized profile management device 206 may have access to a table or a database that links a secure element with a list of service providers with which the user has taken out subscriptions. The sent profile datum may be the most recent profile datum from among the profile data stored for a given service and provided by the provider of this service associated with the secure element 202. According to another alternative, the memory of the centralized profile management device 206 may be partitioned into memory areas in accordance with the service providers, each memory area corresponding to a respective provider, and when the secure element sends a request to retrieve an update of one of its profiles (“pull” mode detailed below), it receives, in response, a profile datum from among the profile data stored in the memory areas associated with the service providers with which the user of the host terminal 201 has taken out a subscription. For this purpose, it is possible to use pointers that refer to the respective addresses of the memory areas associated with the service providers with which the user of the host terminal 201 has taken out a subscription.

In one or more embodiments, the centralized profile management device 206 has an asymmetric key pair, the pair being formed of a public key K_{TS,pub} and a private key K_{TS,priv}. The public key K_{TS,pub} of the centralized profile management device 206 is shared with the secure element 202. In some embodiments, the public key K_{TS,pub} of the centralized profile management device 206 may be sent in a digital certificate, which is issued to the centralized profile management device 206 by a certification body. The centralized profile management device 206 may in turn sign the profile datum (possibly signed beforehand using the private key K_{CPA,priv,i} of the issuing profile management device DPAᵢ 205a, 205b, 205c) with its private key K_{TS,priv}, and send the signed (possibly doubly signed) datum to the management platform 204 for managing the terminal or to the communication agent 203 of the terminal 201. When the secure element 202 receives the profile datum, it in turn checks the signature: it in turn computes a signature based on this datum and on the public key K_{TS,pub} of the centralized profile management device 206, and then compares the two signatures. If they match, the profile in question of the secure element is updated based on the received datum. If not, the profile is not updated and the received profile datum is deleted. Furthermore, when the datum received by the secure element 202 is doubly signed (that is to say based on the private key K_{CPA,priv,i} of the issuing profile management device DPAᵢ 205a, 205b, 205c and on the private key K_{TS,priv} of the centralized profile management device 206), it is necessary for the secure element also to know the public key K_{CPA,pub,i} of the issuing profile management device DPAᵢ 205a, 205b, 205c. In some embodiments, the public key K_{CPA,pub,i} of the profile management device DPAᵢ 205a, 205b, 205c may be sent by the centralized profile management device 206 to the secure element 202 (via the management platform 204 for managing the terminal or to the communication agent 203 of the terminal 201). Furthermore, this public key K_{CPA,pub,i} of the profile management device DPAᵢ 205a, 205b, 205c may be sent by the centralized profile management device 206 in its digital certificate, which is possibly signed by the centralized profile management device 206 using its private key K_{TS,priv}. When the data are doubly signed, the secure element 202 checks the two signatures, one based on the public key K_{CPA,pub,i} of the issuing profile management device DPAᵢ 205a, 205b, 205c, and the other based on the public key K_{TS,pub} of the centralized profile management device 206. If both checks are successful, then the profile in question of the secure element is updated based on the received datum. If not, the profile is not updated and the received profile datum is deleted. This double check makes it possible firstly to check that the profile datum originates from an “authorized” entity, and secondly that it has not been modified since it was sent by the issuing external profile management device DPAᵢ 205a, 205b, 205c.

It should be noted that the external profile management devices DPAᵢ 205a, 205b, 205c do not communicate directly with the host terminal 201 or with the management platform 204 for managing the terminal. The profiles are sent from the external profile management devices DPAᵢ 205a, 205b, 205c to the centralized profile management device 206, which in turn transmits them to the host terminal 201. The host terminal 201 (or the remote management platform 204 for managing the terminal) thus receives profiles from only one entity, thereby solving the abovementioned certification problems and facilitating the management of changes of service provider.

Indeed, it is no longer necessary to certify all premises where the external profile management devices DPAᵢ 205a, 205b, 205c are located, but only premises where the centralized profile management device 206 is located, since this is the only entity that sends data to the secure element 202.

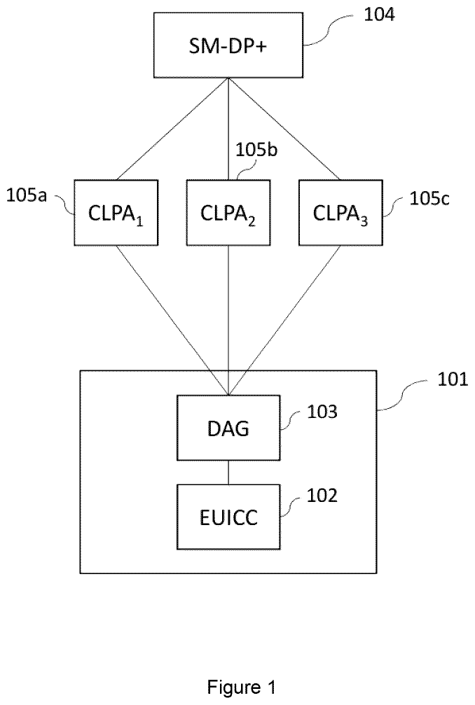

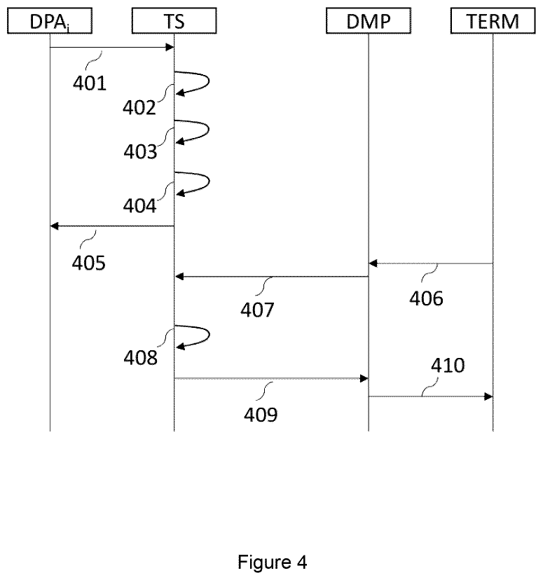

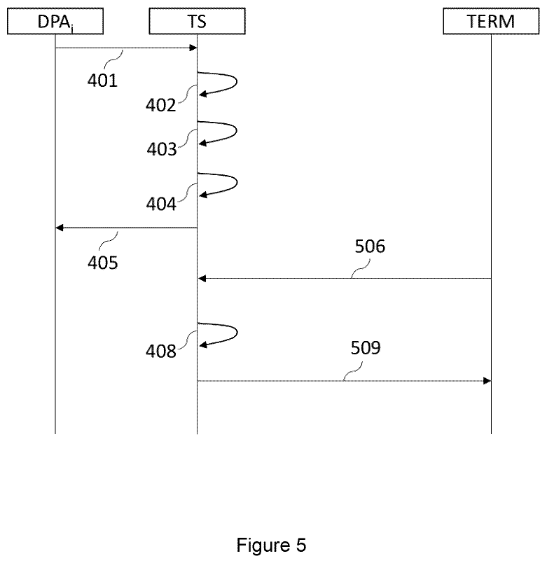

Furthermore, according to some embodiments, profiles are acquired in “pull” mode, that is to say at the request of the secure element 202. In these embodiments, the secure element 202 sends, via the communication agent 203, an interrogation request to ascertain whether a profile datum (corresponding to a new profile/a new version of a profile) is available. In the system of FIG. 1, this request is sent to the external profile management device CLPAᵢ 105a, 105b, 105c of the service provider associated with the profile in question. However, it is possible for the user to change service provider, or for the service provider to change external profile management device CLPAᵢ 105a, 105b, 105c. In such cases, the interrogation request might not be sent to the correct external profile management device CLPAᵢ 105a, 105b, 105c. Indeed, no mechanism is provided for dynamically managing, in the secure element 202, changes of service provider or address of the servers of the service providers for a given service. In the system of FIG. 2, this problem no longer arises, since the interrogation request is sent to the centralized profile management device 206 (as detailed with reference to FIGS. 4 and 5) the network address of which is fixed. The provider is changed transparently for the terminal 201, and the interrogation request cannot be sent to the wrong entity.

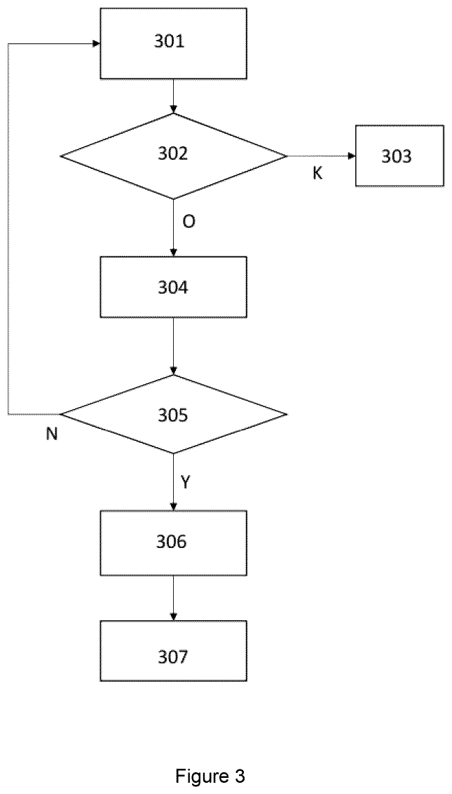

FIG. 3 shows one example of a flowchart of a method for managing a service profile according to one or more embodiments of the invention. In a first step 301, the centralized profile management device 206 receives a profile datum for a given service.

Optionally, this profile datum is signed using the private key K_{CPA,priv,i} of the profile management device DPAᵢ 205a, 205b, 205c from which the profile datum was received, as detailed above. The signature may then be checked (step 302) using the public key K_{CPA,pub,i} of the profile management device DPAᵢ 205a, 205b, 205c from which the profile datum was received. If the check fails (step 302, arrow “K” in FIG. 3), the datum is deleted (step 303). If the check is successful (step 302, arrow “O” in FIG. 3), the datum is stored in a memory of the centralized profile management device 206 in association with the service in question (step 304). As long as no event that triggers updating of a profile of the secure element associated with the service in question is detected (step 305, arrow “N”), the centralized profile management device 206 continues to receive profile data for the service in question (step 301), possibly to check them (step 302) and to delete them (step 303) or store them in memory (step 304). When an event that triggers updating of a profile of the secure element associated with the service in question is detected (step 305, arrow “Y”), the most recent profile datum from among the stored profile data associated with the service in question is sent to the communication agent 203 or to the remote management platform 204 for managing the terminal (step 307). Optionally, the profile datum may be signed using the private key K_{TS,priv} of the centralized profile management device 206 (step 306) before being sent in step 307, as detailed above.

The event that triggers updating of a profile of the secure element may be any event that causes the most recent profile datum to be sent by the centralized profile management device 206 to the communication agent 203 or to the remote management platform 204 for managing the terminal. In some embodiments, this trigger event may be the receipt, by the centralized profile management device 206, of an interrogation request from the secure element 202 and sent via the communication agent 203, to ascertain whether a profile datum associated with a given service is available (such an interrogation request may in particular comprise an identifier of the service in question). These embodiments correspond to a “pull mode”, and some examples are detailed in FIGS. 4 and 5. As an alternative, this trigger event may correspond to the receipt, from the profile management device DPAᵢ 205a, 205b, 205c that sends the datum, that the profile has to be updated as soon as possible or upon receipt of the datum from the profile management device DPAᵢ 205a, 205b, 205c. According to another alternative, the trigger events correspond to predefined times (for example periodically) at which a profile has to be updated (for example every week, or each time the host terminal is restarted, etc.).

FIG. 4 shows steps of a method for managing a service profile according to one particular embodiment of the invention.

This embodiment corresponds to a “pull” mode, in which the communication agent 203 of the host terminal 201 is configured to send interrogation requests to the centralized profile management device 206 (possibly via the remote management platform 204 for managing the terminal) so as to retrieve, in return, a profile datum in order to update a profile of the secure element 202 of the host terminal 201. Furthermore, in the embodiment of FIG. 4, it is assumed that the host terminal is managed by a remote management platform 204 for managing the terminal.

In step 401, a profile management device DPAᵢ 205a, 205b, 205c sends (“pushes”) a profile datum to the centralized profile management device 206 (denoted TS in FIG. 4). As detailed above, this profile datum may be signed. In this case, the signature of the profile datum may be checked (step 402) and stored in the memory of the centralized profile management device 206 only if the check is successful. The profile datum is stored in association with the corresponding service, and in association with a version datum (version number of the profile associated with the received profile datum or date of receipt of the profile datum, for example). Furthermore, the profile datum may possibly be signed a second time using the private key K_{TS,priv} of the centralized profile management device 206 (step 403). The signed/doubly signed profile datum is then encapsulated in a packet (step 404), which is stored in the centralized profile management device 206. In one or more embodiments, the packet may furthermore comprise a service identification datum and/or an identifier of the secure element for which it is intended. In optional step 405, the centralized profile management device 206 sends a notification to the profile management device DPAᵢ 205a, 205b, 205c to inform it of the result of the processing carried out (steps 402 to 403) on the previously received profile datum. In a way, it acknowledges the receipt and storage of the received profile datum.

Steps 401 to 405 may be reiterated for a plurality of profile data received from various profile management devices DPAᵢ 205a, 205b, 205c and for various services. After a few iterations of steps 401 to 405, the centralized profile management device 206 may have in memory a plurality of packets intended for one and the same secure element 202, of which at least two packets are associated with one and the same service and originate from two different profile management devices DPAᵢ 205a, 205b, 205c.

In step 406, the communication agent 203 of the host terminal 201 (denoted TERM in FIG. 4) sends an interrogation request to the remote management platform 204 (denoted DMP in FIG. 4) for managing the terminal, which is transmitted to the centralized profile management device 206 in step 407. The interrogation request may, according to the embodiments, comprise an identifier of the secure element and/or an identifier of the service for which it is asked whether an update is available. Interrogation requests may for example be sent periodically (for example every week) or following the action of a user of the host terminal 201.

In one or more embodiments, the interrogation request may be signed using a private key K_{SE,priv} of the secure element, the private key K_{SE,priv} forming part of an asymmetric key pair (K_{SE,priv}, K_{SE,pub}) formed of a private key K_{SE,priv} and a public key K_{SE,pub} that are associated with the secure element 202. The public key K_{SE,pub} of the secure element 202 may be shared with the centralized profile management device 206. Upon receipt of the interrogation request (step 407), the centralized profile management device 206 may check the signature of the request in step 408 with the public key K_{SE,pub} of the secure element 202. If the check fails, the interrogation request is ignored. If the check is successful, the centralized profile management device 206 sends, to the remote management platform 204 for managing the terminal, the most recent profile datum from among the profile data stored on the centralized profile management device 206 and associated with the service in question (step 409). The service in question may be determined for example based on a service identifier contained in the interrogation request. As an alternative, the interrogation request does not comprise a service identifier and, in step 409, the centralized profile management device 206 sends, for each service for which it stores a profile datum, the most recent profile datum associated with this service. In other words, the centralized profile management device 206 sends a plurality of profile data, each one being the most recent profile datum for a given service. In step 410, the one or more profile data are sent from the remote management platform 204 for managing the terminal to the communication agent 203 of the terminal 201, so as to then be transmitted to the secure element 202. The secure element may then update the one or more profiles corresponding to the one or more received profile data, provided that the one or more signatures associated with the one or more received profile data are valid.

FIG. 5 shows one alternative embodiment to the embodiment shown in FIG. 4. According to this embodiment, the host terminal is not managed by a remote management platform 204 for managing the terminal, and the communication agent 203 communicates directly with the centralized profile management device 206.

Steps 401 to 405 and 408 are the same as in FIG. 4. Steps 506 and 509 correspond respectively to steps 406-407, on the one hand, and 409-410, on the other hand, of FIG. 4. In other words, in step 506, the interrogation request is sent directly from the communication agent 203 of the host terminal 201 (denoted TERM in FIG. 5) to the centralized profile management device 206 (denoted TS in FIG. 5) and, in step 509, the one or more profile data are sent directly from the centralized profile management device 206 to the communication agent 203 of the host terminal 201. As in FIG. 4, the one or more profile data received by the communication agent 203 are then transmitted to the secure element 202. The secure element may then update the one or more profiles corresponding to the one or more received profile data, provided that the one or more signatures associated with the one or more received profile data are valid.

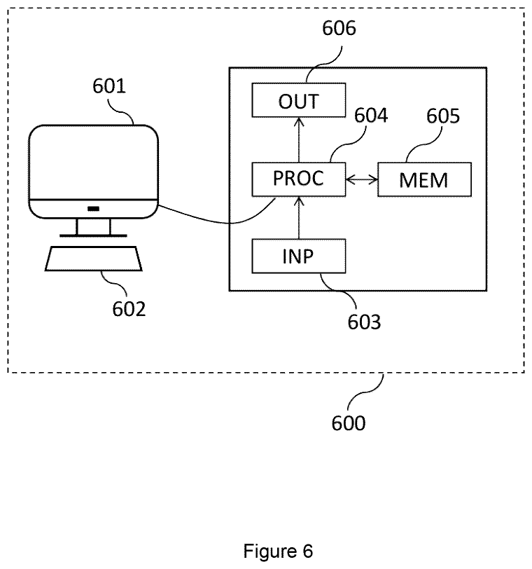

FIG. 6 shows one example of a centralized profile management device for carrying out a transaction according to one or more embodiments of the invention.

In this embodiment, the device 600 comprises a memory 605 (denoted MEM in FIG. 6) for storing instructions allowing the method to be implemented, the received profile data, and temporary data for carrying out the various steps of the method as described above.

The device furthermore comprises a circuit 604 (denoted PROC in FIG. 6). This circuit may be for example:
a processor able to interpret instructions in the form of a computer program, or
an electronic card in which the steps of the method of the invention are described in silicon, or else
a programmable electronic chip such as an FPGA (field-programmable gate array) chip, such as a SOC (system on chip) or else such as an ASIC (application-specific integrated circuit).

SOCs or systems on chip are embedded systems that integrate all of the components of an electronic system into a single chip. An ASIC is a specialized electronic circuit that groups together functionalities tailored to a given application. ASICs are generally configured when they are manufactured and are able only to be simulated by the user. Field-programmable gate array (FPGA) programmable logic circuits are user-reconfigurable electronic circuits.

The device 600 comprises at least one input interface 603 (denoted INP in FIG. 6) for receiving profile data from a profile management device DPAᵢ 205a, 205b, 205c, and one output interface 606 (denoted OUT in FIG. 6) for providing profile data to the management platform 204 for managing the terminal or to the communication agent 203 of the terminal 201. Finally, the centralized device may comprise a screen 601 and a keyboard 602 in order to allow easy interaction with a user. Of course, the keyboard is optional, in particular in the context of a centralized device in the form of a touchscreen tablet, for example.

Depending on the embodiment, the device 600 may be a computer, a computer network, an electronic component, or another apparatus comprising a processor operatively coupled to a memory, and also, depending on the embodiment chosen, a data storage unit, and other associated hardware elements such as a network interface and a media reader for reading a removable storage medium and writing to such a medium (not shown in the figure). The removable storage medium may be for example a compact disc (CD), a digital video/versatile disc (DVD), a flash disk, a USB key, etc.

Depending on the embodiment, the memory, the data storage unit or the removable storage medium contains instructions that, when they are executed by the control circuit 604, cause this control circuit 604 to carry out or control the input interface 603, output interface 606, data storage in memory 605 and/or data processing parts of the exemplary implementations, described herein, of the proposed method.

The control circuit 604 may be a component controlling the units 603, 605 and 606 of the device 600.

Furthermore, the device 600 may be implemented in the form of software, in which case it takes the form of a program able to be executed by a processor, or in the form of hardware, such as an application-specific integrated circuit (ASIC), a system on chip (SOC), or in the form of a combination of hardware elements and software elements, such as for example a software program intended to be loaded onto and executed on an electronic component described above (for example FPGA, processor). The device 600 may also use hybrid architectures, such as for example architectures based on a CPU+FPGA, a GPU (graphics processing unit) or an MPPA (multi-purpose processor array).

Moreover, the block diagram shown in FIG. 3 is one typical example of a program in which some instructions may be implemented at the described centralized profile management device. In this respect, FIG. 3 may correspond to the flowchart of the general algorithm of a computer program within the meaning of the invention.

Although the present invention has been described above with reference to specific embodiments, the present invention is not limited to these specific embodiments, and modifications that fall within the scope of the present invention will be obvious to a person skilled in the art.

Many other modifications and variations will become clear to a person skilled in the art on referring to the above illustrative embodiments, which are given merely by way of example and which do not limit the scope of the invention, said scope being defined solely by the appended claims. In particular, the various features of the various embodiments may be exchanged, where appropriate.

1. A method for managing service profiles of a secure element of a host terminal, the management method being implemented by a centralized profile management device external to the host terminal and comprising:
receiving, from a plurality of processing devices, profile data corresponding to one and the same service and intended for the secure element;
storing in memory profile data from among the received profile data, each stored profile datum being stored in association with said service;
detecting an event that triggers updating of a service profile of the secure element for said service; and
upon detection of said event, sending, to the host terminal, the most recent profile datum from among the stored profile data associated with said service.

2. The method as claimed in claim 1, wherein the centralized profile management device furthermore receives other profile data that are intended for at least one other secure element, wherein each profile datum is received with an identifier of a secure element for which it is intended, wherein each stored profile datum is furthermore stored in association with the identifier of the secure element for which it is intended, and wherein the most recent profile datum from among the stored profile data associated with said service is sent with the identifier of the secure element for which it is intended.

3. The method as claimed in claim 1, wherein each stored profile datum is associated, respectively, with a version datum, wherein the version datum is a time of receipt by the centralized profile management device or a version number of a profile associated with the profile datum, wherein the sent profile datum corresponds to the profile datum having the most recent version datum from among the stored profile data associated with said service.

4. The method as claimed in claim 1, wherein each profile datum is received with a respective service identification datum, the method furthermore comprising:
for each profile datum received and stored in memory, determining a corresponding service based on the respective service identification datum received with said profile datum and storing the profile datum in association with the determined corresponding service.

5. The method as claimed in claim 4, wherein a service identification datum from among the received service identification data is:
an identifier of the processing device from which the profile datum was received;
a network address of the processing device from which the associated profile datum was received;
an identifier of a service provider managing a service associated with the received profile datum; or
an identifier of a service associated with the received profile datum.

6. The method as claimed in claim 1, furthermore comprising, for each received profile datum associated with the service:
determining a service provider associated with the profile datum and storing the profile datum in association with the determined service provider;
upon detection of said event, determining, based on a database, a current service provider associated with the secure element for said service;
wherein the sent profile datum is the most recent profile datum from among the stored profile data associated with said service and the current service provider associated with the secure element for said service.

7. The method as claimed in claim 1, wherein the detection of the event that triggers the updating of the service profile of the secure element comprises:
receiving, from the host terminal or from a management platform for managing the host terminal, an interrogation request comprising identification information in relation to said given service.

8. The method as claimed in claim 1, wherein each processing device from among the plurality of processing devices has a respective first asymmetric key pair, each first asymmetric key pair comprising a private key and a public key, the public key being shared between the processing device and the centralized profile management device, wherein each received profile datum is signed with the private key of the issuing processing device, the method furthermore comprising, for each received profile datum:
the centralized profile management device checking the signature of the profile datum based on the public key of the issuing processing device; and
storing the received profile datum in the memory of the centralized profile management device only if the check is successful.

9. The method as claimed in claim 1, wherein the centralized profile management device has a second asymmetric key pair, the second asymmetric key pair comprising a private key of the centralized profile management device and a public key of the centralized profile management device, the public key of the second asymmetric key pair being shared between the centralized profile management device and the secure element, wherein, for each stored profile datum, said profile datum is signed using the private key of the centralized profile management device.

10. A centralized profile management device for managing communication profiles of a secure element of a host terminal, the centralized profile management device being external to the host terminal, the centralized profile management device being configured to:
receive, from a plurality of processing devices, profile data corresponding to one and the same service and intended for the secure element;
store in memory profile data from among the received profile data, each stored profile datum being stored in association with said service;
detect an event that triggers updating of a service profile of the secure element for said service; and
upon detection of said event, send, to the host terminal, the most recent profile datum from among the stored profile data associated with said service.

11. A system comprising a host terminal having a secure element, a centralized profile management device external to the host terminal and a plurality of processing devices, wherein the centralized profile management device is configured to:
receive, from a plurality of processing devices, profile data corresponding to one and the same service and intended for the secure element;
store in memory profile data from among the received profile data, each stored profile datum being stored in association with said service;
detect an event that triggers updating of a service profile of the secure element for said service;
upon detection of said event, send, to the host terminal, the most recent profile datum from among the stored profile data associated with said service; and
wherein the secure element is configured to:
receive the profile datum sent by the centralized profile management device; and
update the service profile based on the received profile datum.

12. The system as claimed in claim 11, wherein each processing device from among the plurality of processing devices has a respective first asymmetric key pair, each first asymmetric key pair comprising a private key and a public key, the public key being shared between the processing device and the centralized profile management device, wherein each received profile datum is signed with the private key of the issuing processing device, wherein the centralized profile management device is furthermore configured, for each received profile datum, to:
check the signature of the profile datum based on the public key of the issuing processing device; and
store the received profile datum in memory only if the check is successful.

13. The system as claimed in claim 11, wherein the centralized profile management device has a second asymmetric key pair, the second asymmetric key pair comprising a private key of the centralized profile management device and a public key of the centralized profile management device, the public key of the second asymmetric key pair being shared between the centralized profile management device and the secure element, wherein, for each stored profile datum, said profile datum is signed using the private key of the centralized profile management device before being sent to the host terminal.

14. The system as claimed in claim 12, wherein the public key of each processing device from among the plurality of processing devices is shared with the secure element, wherein the secure element is configured to:
upon receipt of the signed profile datum, check the associated signatures using the public key of the processing device that issued the profile datum and the public key of the centralized profile management device; and
update the service profile based on the received profile datum only if the check is successful.

15. A computer program product comprising instructions for implementing the method as claimed in claim 1 when this program is executed by a processor.
